(19) United States
(12) Patent Application Publication
(10) Pub. No.: US 2012/0057035 A1
(43) Pub. Date: Mar. 8, 2012

(54) FORCE COMPENSATION SYSTEMS AND METHODS

(76) Inventors: Shane D. Voss, Fort Collins, CO (US); Jason Yost, Windsor, CO (US); Jeffrey D. Schwartz, Loveland, CO (US)

(21) Appl. No.: 12/874,924

(22) Filed: Sep. 2, 2010

(51) Int. Cl. H04N 5/228

(52) U.S. Cl. 348/208.2; 348/E05.031

(57) ABSTRACT

A positioning system and method are disclosed. The system includes an external force sensor configured to measure a magnitude of at least one external force acting upon a movable object disposed within a camera and to generate a force signal that is indicative of the magnitude of the at least one external force. The system also includes a positioning motor configured to control a physical location of the movable object in response to a positioning signal. The system further includes a position controller configured to generate the positioning signal at a magnitude that is adjusted in response to the force signal to substantially compensate for the at least one external force in controlling the physical location of the movable object.

### BACKGROUND

Many electronic devices, including portable electronic devices, implement motor-driven positioning systems to move and/or maintain components therein to and/or in specific locations. As an example, the electronic device can be or can include a camera. The associated camera lens can be moved to and maintained in specific locations for focusing the associated camera to obtain clear photographs. Such specific locations may be predetermined and may have very sensitive tolerances in which the associated lens is to be moved and maintained for proper focus. However, external forces applied to the electronic device, such as including gravity, can affect the positioning of the lens, thus degrading performance of the camera.

### BRIEF DESCRIPTION OF THE DRAWINGS

FIG. 1 illustrates an example embodiment of an electronic positioning control system.

FIG. 2 illustrates an example embodiment of an external force sensor.

FIG. 3 illustrates an example embodiment of a camera system.

FIG. 4 illustrates an example embodiment of a lens focusing system.

FIG. 5 illustrates another example embodiment of a lens focusing system.

FIG. 6 illustrates an example embodiment of a method for positioning a camera lens in a camera.

### DETAILED DESCRIPTION

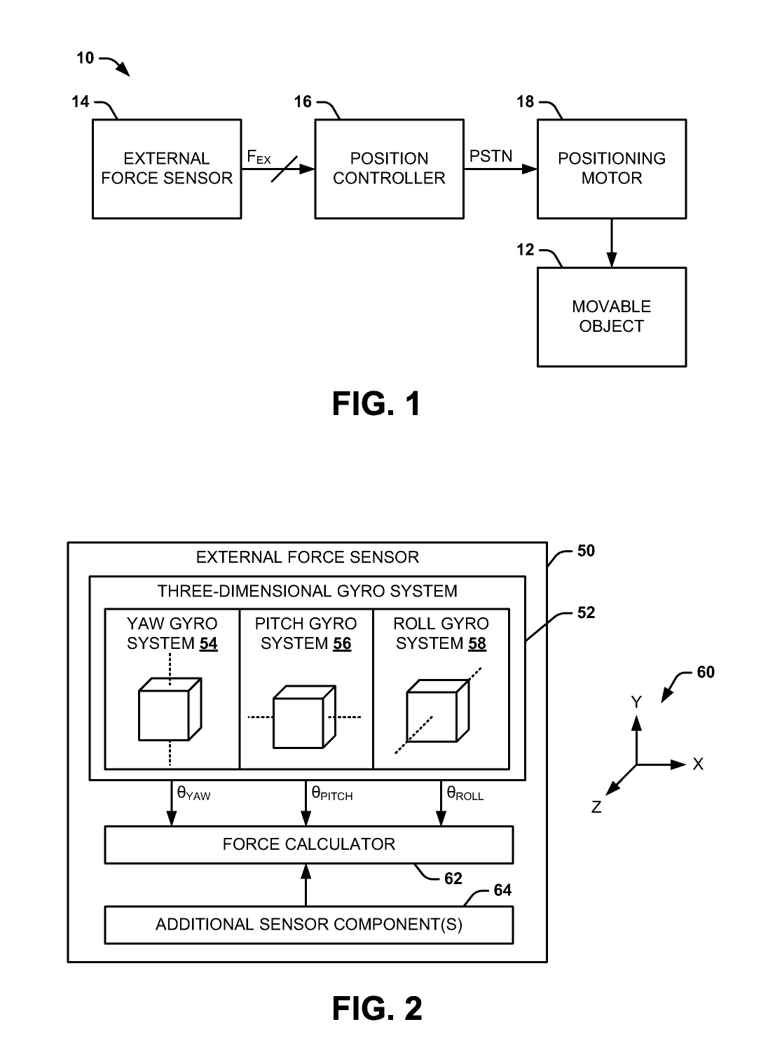

FIG. 1 illustrates an example embodiment of an electronic positioning control system 10. The electronic positioning control system 10 can be implemented in a variety of electronic devices to position a movable object 12. As described herein, “positioning” and “controlling a location” of the movable object 12 describes moving the movable object 12 and/or maintaining a stationary position of the movable object 12. As an example, the associated electronic device can include a camera, such as in a wireless communication device (e.g., wireless telephone), or can be a camera itself. Thus, the movable object 12 can be configured as a camera lens that is movable to precise locations and maintained at the precise locations to properly focus the associated camera to take clear photographs. Furthermore, as described herein, the electronic positioning control system 10 can be configured to substantially compensate for external forces that are applied to the movable object 12, such as gravity, in controlling the location of the movable object 12. As described herein, “external force” describes forces acting upon the movable object 12 from the external environment of the associated electronic device.

The electronic positioning control system 10 includes an external force sensor 14. As an example, the external force sensor 14 can be configured as any of a variety of different types of sensors, such as a gyroscope system, a level system, an accelerometer, or a magnetic sensor system. The external force sensor 14 is configured to calculate at least one external force that is applied to the associated electronic device. The at least one external force can include gravity. As an example, the external force sensor 14 can be configured to determine at least one of a yaw, pitch, and roll angle of the associated electronic device, such that the magnitude of the force affecting the movable object 12 from gravity can be calculated. However, the external force sensor 14 can also be configured to calculate additional external forces acting upon the associated electronic device, such as acceleration resulting from movement of the associated electronic device.

The external force sensor 14 can generate one or more signals, demonstrated in the example of FIG. 1 as F_{EX}, that are indicative of the magnitude and direction of the at least one external force. The signal(s) F_{EX} can be analog or digital signals. The signal(s) F_{EX} are provided to a position controller 16. The position controller 16 is configured to control the location of the movable object 12 via a positioning motor 18. In the example of FIG. 1, the position controller 16 controls the positioning motor 18 via a positioning signal PSTN. As an example, the positioning signal PSTN can be a current having a magnitude that dictates the speed and/or force of the positioning motor 18. Therefore, the positioning controller 16 can set the magnitude of the positioning signal PSTN to control the location of the movable object, such that the positioning motor 18 moves the movable object 12 to and/or maintains the movable object 12 at a specific location in response to the positioning signal PSTN. It is to be understood that the movable object 12 can be moved by the positioning motor in any of a variety of ways, such as axial motion, rotational motion, and/or translational motion.

In addition, the position controller 16 is configured to adjust the magnitude of the positioning signal PSTN in response to the signal(s) F_{EX} to substantially compensate for the effects of the at least one external force. As an example, the position controller 16 may command the positioning motor 18 to maintain a specific position of the movable object 12 based on the positioning signal PSTN. However, the at least one external force may act upon the movable object 12, thus potentially displacing the movable object 12 from a desired location at which the movable object 12 is to be maintained or acting against the movement of the movable object 12. Accordingly, as an example, the position controller 16 can increase or decrease the magnitude of the positioning signal PSTN based on the magnitude of the signal(s) F_{EX} to increase or decrease the force of the positioning motor 18 to substantially compensate for the at least one external force acting upon the movable object 12. As another example, to maintain a stationary location of the movable object 12, the position controller 16 can activate the positioning motor 18 when it otherwise would not to prevent the movable object 12 from being displaced from the stationary location by the at least one external force.

Therefore, the electronic positioning control system 10 can be configured to substantially mitigate the effects of external forces acting upon the movable object 12. As a result, the associated electronic device in which the movable object 12 is included can operate with better quality and reliability. In addition, the electronic positioning control system 10 acts as an open-loop control system based on measuring the at least one external force, as opposed to monitoring the motion and/or position of the movable object in a closed-loop control system. Therefore, the electronic positioning control system 10 can operate more quickly and in a less complicated manner than typical closed-loop control systems, such as servo systems.

FIG. 2 illustrates an example of an external force sensor 50. As an example, the external force sensor 50 can correspond to the external force sensor 14 in the example of FIG. 1. Thus, reference is to be made to the example of FIG. 1 in the following description of the example of FIG. 2.

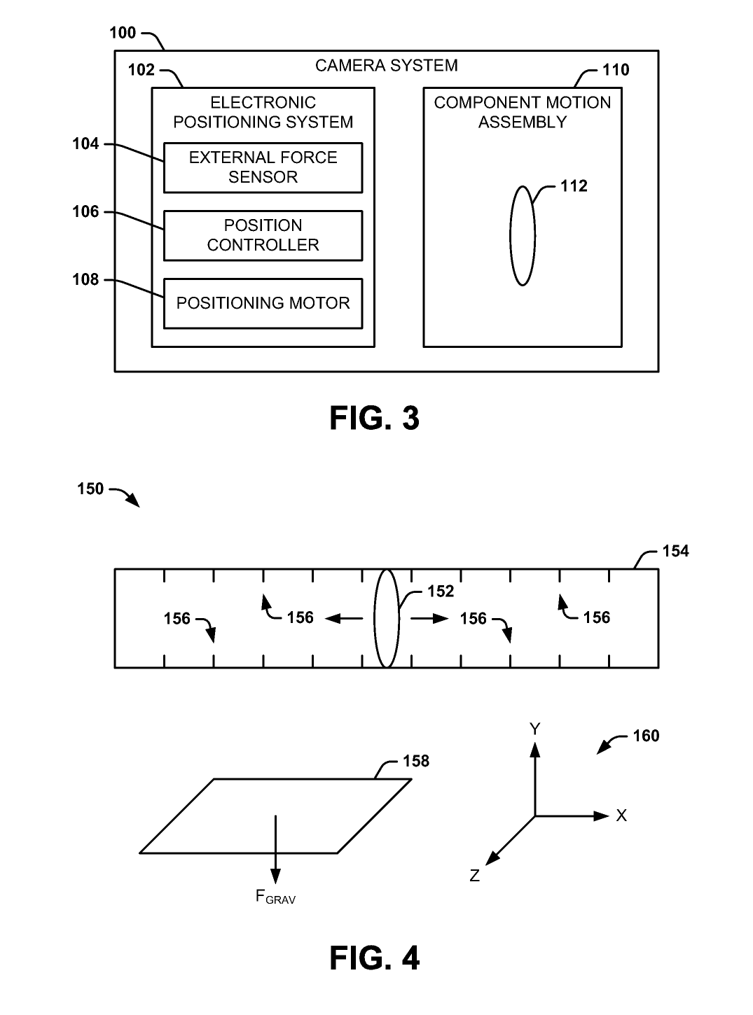

The external force sensor 50 includes a three-axis gyro system 52 that are configured to determine yaw, pitch, and roll angles associated with the electronic device in which the electronic positioning control system 10 is included. The three-axis gyro system 52 includes a yaw gyro system 54, a pitch gyro system 56, and a roll gyro system 58. In the example of FIG. 2, the yaw gyro system 54 can have a sensitive axis about the Y-axis, the pitch gyro system 56 can have a sensitive axis about the X-axis, and the roll gyro system 58 can have a sensitive axis about the Z-axis. The axes of rotation of the respective gyro systems 54, 56, and 58 are indicated in the example of FIG. 3 by a Cartesian coordinate system 60. Thus, the yaw, pitch, and roll gyro systems 54, 56, and 58 can be configured to measure respective rotation angles θ_{YAW}, θ_{PITCH}, and θ_{ROLL} associated with the electronic device, and thus motion of the electronic device about all three of the sensitive axes X, Y and Z.

In the example of FIG. 2, each of the yaw, pitch, and roll gyro systems 54, 56, and 58 are demonstrated as outputting signals that include the respective rotation angles θ_{YAW}, θ_{PITCH}, and θ_{ROLL} to a force calculator 62. The force calculator 62 can thus be configured to calculate the at least one external force on the electronic device based on the yaw, pitch, and roll orientation of the electronic device. As an example, the force calculator 62 can calculate the force caused by gravity on the electronic device based at least on pitch the pitch angle θ_{PITCH} of the electronic device, and possibly also based on the yaw and roll angles θ_{YAW} and θ_{ROLL}. As another example, the external force sensor 50 can also include one or more additional force sensing components 64, such as including an accelerometer and/or magnetic sensor, that can detect one or more additional external forces. Therefore, the force calculator 62 can likewise calculate how the additional forces detected by the one or more additional force sensing components 64 act upon the movable object 12 based on the yaw, pitch, and roll orientation of the electronic device, as determined by the three-axis gyro system 52.

It is to be understood that the external force sensor 50 is not intended to be limited to the example of FIG. 2. As an example, the three-axis gyro system 52 may include only one or two gyro systems, and thus less than all three of the yaw, pitch, and roll gyro systems 54, 56, and 58. As another example, some electronic devices, such as touch-screen wireless telephones, may include existing orientation sensors that are implemented for orienting the user screen based on the orientation of the electronic device. Thus, the external force sensor 52 may not include any of the yaw, pitch, and roll gyro systems 54, 56, and 58, but may instead obtain the yaw, pitch, and/or roll angles θ_{YAW}, θ_{PITCH}, and θ_{ROLL} from additional sensors or circuitry of the electronic device. Thus, the external force sensor 50 can be configured in a variety of ways.

FIG. 3 illustrates an example embodiment of a camera system 100. The camera system 100 can be a standalone camera, such as a handheld digital still-photo or video camera or larger camera, or can be implemented as part of a wireless telephone (i.e., camera phone).

The camera system 100 includes an electronic positioning system 102, which can be configured substantially similar to the electronic positioning system 10 in the example of FIG. 1. Specifically, the electronic positioning system 102 includes an external force sensor 104, a position controller 106, and a positioning motor 108. Similar to as described above in the example of FIG. 1, the external force sensor 104 can be configured to calculate at least one external force acting upon the camera system 100 and to provide a signal that is indicative of the magnitude of the force. Also similar to as described above in the example of FIG. 1, the position controller 106 can thus generate a positioning signal that controls the positioning motor 108 and which is adjusted based on the at least one external force, as calculated by the external force sensor 104.

In addition, the camera system 100 includes a component motion assembly 110. The component motion assembly 110 includes a lens 112, which can correspond to the movable object 12 in the example of FIG. 1, as well as mechanical components that allow movement of the lens 112 for focusing the camera system. As an example, the component motion assembly 110 can correspond to a focus scan assembly associated with the lens, such that upon activation of the camera system and/or periodically, the position controller 106 can implement a focus scan operation. For example, the focus scan operation can be such that the position controller 106 commands the positioning motor 108 to move the lens 112 to a plurality of predetermined axial positions via mechanical components of the component motion assembly 110 to determine the most ideal position of the lens 112 for optimal focus. As another example, the component motion assembly 110 could correspond to motion assemblies that also include one or more motors for zoom and/or aperture positioning of the lens 112 and/or additional mechanical components of the camera system 100. The electronic positioning system 102 can be configured to substantially compensate for the at least one external force in controlling the respective motor to move and/or maintain the lens 112 and/or additional mechanical components of the camera system 100 to and/or at specific locations.

FIG. 4 illustrates an example embodiment of a lens focusing system 150. The lens focusing system 150 can correspond to a focus scan operation, such as described above in the example of FIG. 3. Thus, reference is to be made to the example of FIG. 3 in the following description of the example of FIG. 4.

The lens focusing system 150 includes a lens 152 moving axially within an aperture ring 154, demonstrated in an axial cross-section in the example of FIG. 4, such as based on operation of the positioning motor 108. It is to be understood that the lens 152 and the aperture ring 154 may not be demonstrated in scale with respect to each other in the example of FIG. 4, but that the length of the aperture ring 154 may be exaggerated for ease in demonstration. During the focus scan operation, the positioning controller 106 is configured to move the lens 152 to each of a plurality of predetermined focal positions 156. The example of FIG. 4 demonstrates ten predetermined focal positions 156, but it is to be understood that there could be more or less predetermined focal positions 156 in a given focus scan operation. The predetermined focal positions 156 correspond to focal points associated with the lens, such that the camera system 100 can determine the optimal focal point at which to move and maintain the lens 152 to obtain the clearest photograph.

In addition, the example of FIG. 4 demonstrates a fixed plane 158 in three-dimensional space. The fixed plane 158 is defined by the origin and all values of the X- and Z-axes of a Cartesian coordinate system 160 (i.e., Y=0). The fixed plane 158 is demonstrated such that a force F_{GRAV} resulting from gravity is normal to the fixed plane 158, in the −Y direction. Thus, at a pitch angle θ_{PITCH} of approximately 0°, as demonstrated in the example of FIG. 4, the force F_{GRAV} resulting from gravity does not affect the lens 152 in either direction along the axial length of the aperture ring 154.

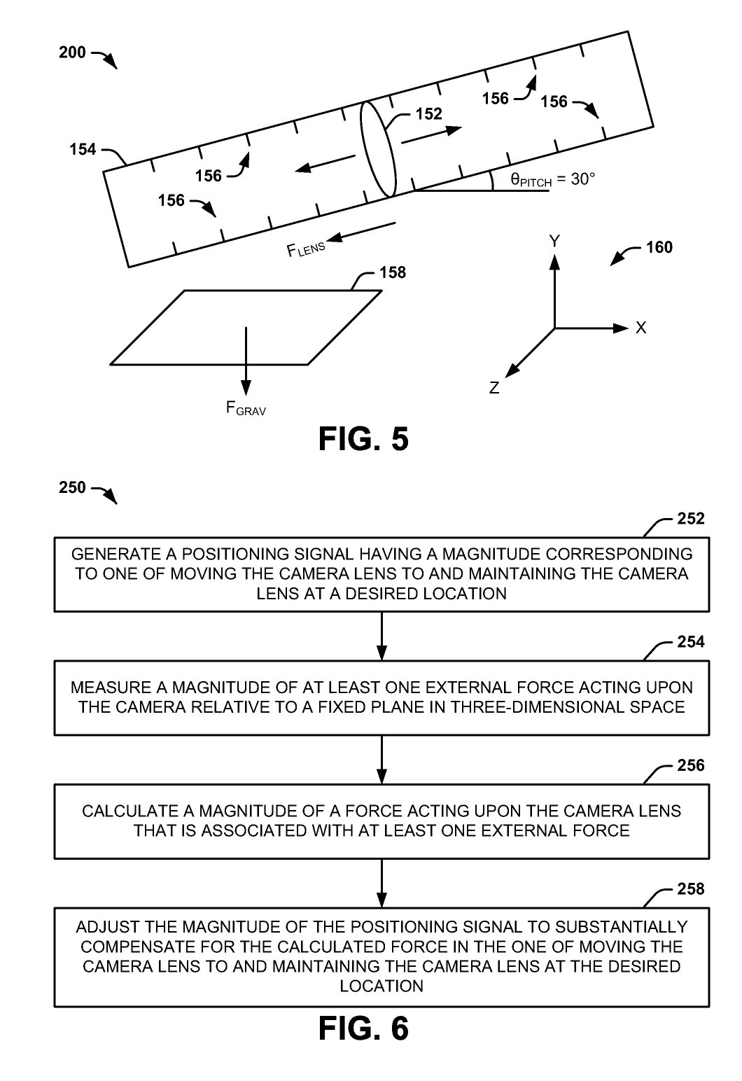

FIG. 5 illustrates an example embodiment of a lens focusing system 200. The lens focusing system 200 can correspond to the focus scan operation described above in the example of FIG. 3. Thus, reference is to be made to the example of FIG. 3 in the following description of the example of FIG. 5, and like reference numbers are used in the example of FIG. 5 as used in the example of FIG. 4.

In the example of FIG. 5, the aperture ring 154 is demonstrated as elevated, such that the pitch angle θ_{PITCH} is demonstrated at approximately 30° relative to the fixed plane 158. Such an orientation could occur based on a user elevating the camera system 100 to take a photograph. Therefore, the force F_{GRAV} acts upon the lens 152 to generate a force F_{LENS} along the axial length of the aperture ring 154, with the force F_{LENS} being approximately equal to one half the force F_{GRAV} (less friction). Similar to as described above in the example of FIG. 4, the lens 152 can be commanded to move to and/or to be maintained at a given one of the predetermined focal positions 156, such as in response to the position signal PSTN. However, in the example of FIG. 5, the force F_{LENS} can act upon the lens 152 to displace the lens 152 from the expected and/or desired position (i.e., at or to a given one of the predetermined focal positions 156).

The external force sensor 104 can thus calculate the magnitude of the force F_{LENS} and provide a signal, (e.g., the signal(s) F_{EX} in the example of FIG. 1) to the position controller 106. Therefore, to move the lens 152 to each of the predetermined focal positions 156, the position controller 106 can adjust the magnitude of the positioning signal (e.g., the positioning signal PSTN in the example of FIG. 1) to substantially compensate for the force F_{LENS}. In addition, upon maintaining the position of the lens 152 at a given one of the predetermined focal positions 156, the position controller 106 can likewise apply and/or adjust the magnitude of the positioning signal to substantially compensate for the force F_{LENS}. As a result, the electronic positioning control system 102 can achieve better photograph resolution for the camera system 100, as well as faster focus scan operations, relative to focus scan operations of typical cameras that increase the outer ranges of the movement of the associated lens to attempt to compensate for gravity.

In addition, in the example of FIGS. 4 and 5, the magnitude of the effects of the force F_{GRAV} on the lens 152 may be different for each of the predetermined focal positions 156. Thus, the position controller 106 can be configured to calculate the adjustment to the positioning signal resulting from the effects of the force F_{GRAV} individually for each of the predetermined focal positions 156. As an example, the position controller 106 can be configured to calculate the adjustments to the positioning signal based on the effects of the force F_{GRAV} on the most proximal and most distal of the predetermined focal positions 156. Thus, the position controller 106 can interpolate the adjustments to the positioning signal for each of the remaining predetermined focal positions 156 by scaling a difference between the adjustments to the most proximal and most distal of the predetermined focal positions 156. Furthermore, it is to be understood that similar methods of controlling the position of the lens 152 and/or additional mechanical components of the camera system 100 and for compensating for effects of external forces can be implemented for other motors in the camera system 100, such as a zoom motor and/or an aperture motor. Accordingly, the electronic positioning control system 102 can provide better accuracy in substantially compensating for the effects of external forces acting upon the camera system 100, such as including gravity.

In view of the foregoing structural and functional features described above, an example methodology will be better appreciated with reference to FIG. 5. While, for purposes of simplicity of explanation, the methodology of FIG. 5 is shown and described as executing serially, it is to be understood and appreciated that the present invention is not limited by the illustrated order, as some embodiments could in other embodiments occur in different orders and/or concurrently from that shown and described herein.

FIG. 5 illustrates an example embodiment of a method 250 for positioning a camera lens in a camera. At 252, a positioning signal having a magnitude corresponding to one of moving the camera lens to and maintaining the camera lens at a desired location is generated. At 254, a magnitude of at least one external force acting upon the camera relative to a fixed plane in three-dimensional space is measured. At 256, a magnitude of a force acting upon the camera lens that is associated with the at least one external force is calculated. At 258, the magnitude of the positioning signal is adjusted to substantially compensate for the calculated force in the one of moving the camera lens to and maintaining the camera lens at the desired location.

What have been described above are examples of the invention. It is, of course, not possible to describe every conceivable combination of components or methodologies for purposes of describing the invention, but one of ordinary skill in the art will recognize that many further combinations and permutations of the invention are possible. Accordingly, the invention is intended to embrace all such alterations, modifications, and variations that fall within the scope of this application, including the appended claims.

What is claimed is:

1. A positioning control system associated with a camera, the system comprising:
an external force sensor configured to measure a magnitude of at least one external force acting upon a movable object disposed within the camera and to generate a force signal that is indicative of the magnitude of the at least one external force;
a positioning motor configured to control a physical location of the movable object in response to a positioning signal; and
a position controller configured to generate the positioning signal at a magnitude that is adjusted in response to the force signal to substantially compensate for the at least one external force in controlling the physical location of the movable object.

2. The system of claim 1, wherein the external force sensor is configured as one of a gyroscope system, a level system, an accelerometer, and a magnetic sensor system.

3. The system of claim 1, wherein the external force sensor is configured to determine at least one of a yaw, pitch, and roll angle associated with an orientation of the movable object relative to a fixed plane in three-dimensional space and to calculate the at least one external force based on the at least one of the yaw, pitch, and roll angle.

4. The system of claim 1, wherein the movable object is configured as at least one mechanical component of a camera, the physical location of which is controlled by the positioning motor configured as at least one of a focus, zoom, and aperture motor, and wherein the at least one external force comprises gravity.

5. The system of claim 4, wherein the at least one mechanical component of the camera comprises a camera lens, wherein the positioning motor is configured to axially move the camera lens to each of a plurality of predetermined focal positions during a focus scan operation, the positioning controller adjusting the magnitude of the positioning signal for each of the plurality of predetermined focal positions.

6. The system of claim 5, wherein the positioning controller is configured to calculate the magnitude of the positioning signal for each of a most proximal and a most distal of the plurality of predetermined focal positions and to scale the magnitude of the positioning signal for each remaining one of the plurality of predetermined focal positions.

7. A handheld electronic device comprising the positioning system of claim 1.

8. A method for positioning a camera lens in a camera, the method comprising:
generating a positioning signal having a magnitude corresponding to one of moving the camera lens to and maintaining the camera lens at a desired location;
measuring a magnitude of at least one external force acting upon the camera relative to a fixed plane in three-dimensional space;
calculating a magnitude of a force acting upon the camera lens that is associated with the at least one external force; and
adjusting the magnitude of the positioning signal to substantially compensate for the calculated force in the one of moving the camera lens to and maintaining the camera lens at the desired location.

9. The method of claim 8, wherein calculating the magnitude of the force comprises determining at least one of a yaw, pitch, and roll angle associated with the camera relative to the fixed plane and calculating the magnitude of the force as a function of gravity based on the at least one of the yaw, pitch, and roll angle.

10. The method of claim 8, further comprising axially moving the camera lens to each of a plurality of predetermined focal positions during a focus scan operation in response to the positioning signal, wherein adjusting the magnitude of the positioning signal comprises adjusting the magnitude of the positioning signal individually for each of the plurality of predetermined focal positions.

11. The method of claim 10, wherein adjusting the magnitude of the positioning signal comprises:
adjusting the magnitude of the positioning signal at each of a most proximal and a most distal of the plurality of predetermined focal positions; and
scaling the magnitude of the positioning signal for each remaining one of the plurality of predetermined focal positions.

12. An electronic device comprising a camera lens, the electronic device comprising:
a sensor configured to measure at least one of a yaw, pitch, and roll angle orientation associated with the camera lens relative to a fixed plane and to generate a force signal that is indicative of a magnitude of at least one external force based on the measured at least one of the yaw, pitch, and roll angle orientation associated with the camera lens;
a positioning motor configured to control a physical location of the camera lens relative to a fixed plane in three-dimensional space in response to a positioning signal; and
a position controller configured to generate the positioning signal at a magnitude that is adjusted in response to the force signal to substantially compensate for the at least one external force.

13. The electronic device of claim 12, wherein the sensor comprises at least one of a gyroscope system, a level system, an accelerometer, and a magnetic sensor system.

14. The electronic device of claim 12, wherein the sensor is configured to calculate the at least one external force as a function of gravity based on the at least one of the yaw, pitch, and roll angle.

15. The electronic device of claim 12, wherein the positioning motor is configured to axially move the camera lens to each of a plurality of predetermined focal positions during a focus scan operation, the positioning controller adjusting the magnitude of the positioning signal for each of the plurality of predetermined focal positions.
